(19) United States
(12) Patent Application Publication
(10) Pub. No.: US 2005/0134679 A1
(43) Pub. Date: Jun. 23, 2005

(54) Margin registration of a scan line in an electrophotographic printer

(76) Inventors: Robert L. Paterson, Nicholasville, KY (US); John P. Richey, Lexington, KY (US); Mark E. K. Lund, Lexington, KY (US); Mark A. Omelchenko, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/727,902

(22) Filed: Dec. 4, 2003

(51) Int. Cl. B41J 2/435

(52) U.S. Cl. 347/250

(57) ABSTRACT

A method of aligning a print image of an electrophotographic machine, the method including the steps of determining a power level of a laser beam, sensing a synch position of the laser beam associated with the scan line and varying a delay time before starting the scan line dependent upon the power level and the synch position.

### BACKGROUND OF THE INVENTION

1. Field of the Invention

The present invention relates to a method of controlling the print registration of an electrophotographic machine, and, more particularly, to a method of altering the registration of a scan line in a laser printer dependent on a power level of a laser.

2. Description of the Related Art

In an inline color laser image printing process, the print medium typically passes through four color developing stations in series, with the colors being black, magenta, cyan and yellow. In order for the multi-color laser to print, so that the colors are coordinated, the drum exposures must be coordinated for each of the four colors so that each will be properly registered on the printed paper.

Any misalignment in the color planes results in print quality problems, which may result in incorrect tints and hues of a color. Changes in the environment, changes in cartridges and components can result in variations in the color intensity of each of the color planes. A typical adjustment to alter the color intensity is to adjust the laser power applicable to that color. An increase in laser power typically increases the light output of the laser diode. More light from the laser diode makes the intensity of the color associated with that particular laser to be more intense or darker.

It is typical in a laser printer to have a scanning laser beam for each of the four color developing stations. Each color is associated with a color toner and the laser impinges multiple scan lines on a photoconductive drum, thereby altering a characteristic on the drum. The toner is attracted to portions of the photoconductive drum and it is then transferred to a transfer belt. The transfer belt is rotated to a second photoconductive drum, where toner associated with the scan line on the transfer belt from the first photoconductive drum needs to align with toner associated with the corresponding scan line to be transferred from the second photoconductive drum. This continues for the third and fourth color developing stations as well.

What is needed in the art is a method of registering scan lines of multiple photoconducting drums in order to avoid undesirable shifts in registration.

### SUMMARY OF THE INVENTION

The present invention provides a method of precisely controlling the registration between multiple laser scanners so that color planes can be accurately registered relative to each other.

The invention comprises, in one form thereof, a method of aligning a print image of an electrophotographic machine on a print medium, the method including the steps of determining the power level of a laser providing at least one photosensitive device, illuminating a light sensor with light from the laser. A signal is generated from the light sensor depending upon the illuminating step, altering the signal dependent upon the power level and starting a scan line from the laser onto at least one development device dependent upon the altered signal.

The invention comprises in another form thereof a method of adjusting the registration of a scan line in an electrophotographic machine, the method including the steps of determining the power level of a laser beam, sensing a sync position of the laser beam associated with the scan line and varying a delay time before starting the scan line dependent upon the power level and the sync position.

An advantage of the present invention is that the laser beams of a multi-color electrophotographic machine can be registered to start each scan line at an appropriate place on each photoconductive drum.

Another advantage is that a variation of laser power is compensated for in order to properly delay the start time of the scan line thereby registering each of the four scan lines in a coordinated manner.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side, sectional view of one embodiment of a multi color laser printer in which the method of the present invention may be used;

FIG. 2 is a cross sectional view of one of the polygon mirrors of FIG. 1 reflecting a laser beam;

FIG. 3 is a fragmentary top view of one of the photoconductive drums of FIG. 1;

FIG. 4 is a schematic side view of one of the laser printheads of FIG. 1 and a corresponding photoconductive drum;

FIG. 5 is a schematic view of a laser beam reflecting upon the polygon mirror of FIG. 2 and illustrating the start points of scan lines;

FIG. 6 is a timing diagram illustrating the relationship between a synchronization signal and a signal for the start of a scan line of FIG. 5 of the laser printer illustrated in FIG. 1; and

FIG. 7 is a block diagram of the operation of one embodiment of the method of the present invention utilized in the printer of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

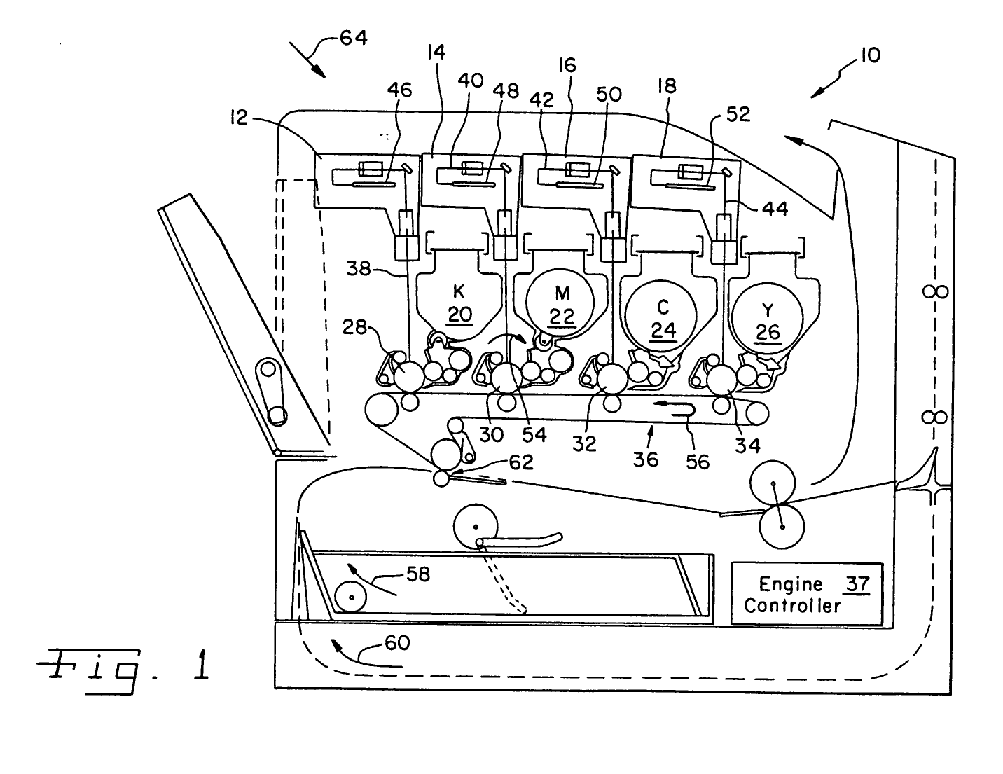

Referring now to the drawings and, more particularly, to FIG. 1, there is shown one embodiment of a multi-color laser printer 10 including laser printheads 12, 14, 16 and 18, a black toner cartridge 20, a magenta toner cartridge 22, a cyan toner cartridge 24, a yellow toner cartridge 26, photoconductive drums 28, 30, 32 and 34, an intermediate transfer member belt 36 and an engine controller 37.

Each of laser printheads 12, 14, 16 and 18 project a respective laser beam 38, 40, 42 and 44 off of a respective polygon mirror 46, 48, 50 or 52. As each of polygon mirrors 46, 48, 50 and 52 rotates, it scans a respective one of reflected laser beams 38, 40, 42 and 44 in a scan direction, perpendicular to the plane of FIG. 1, across a respective photoconductive drum 28, 30, 32 and 34. Each of photoconductive drums 28, 30, 32 and 34, also known as photosensitive development device 28, 30, 32 and 34, is negatively charged to approximately −950 volts and is subsequently discharged to a level of approximately −250 volts in the area of its peripheral surface that is impinged by a respective one of laser beams 38, 40, 42 and 44. During each scan of a laser beam across a photoconductive drum, each of photoconductive drums 29, 30, 32 and 34 is continuously rotated, clockwise in the embodiment shown, in a process direction indicated by direction arrow 54. The scanning of laser beam 38, 40, 42 and 44 across the peripheral surfaces of the respective photoconductive drums is cyclically repeated, thereby discharging the areas of the peripheral surfaces on which the laser beams impinge.

The toner in each toner cartridge 20, 22, 24 and 26 is negatively charged and is transported as a thin, uniform layer on the surface of a developer roll with a core potential of approximately −600 volts. When the toner from cartridges 20, 22, 24 and 26 is brought into contact with a respective photoconductive drum 28, 30, 32 and 34, the toner is attracted to and adheres to the portions of the peripheral surfaces of the drums that have been discharged to −250 volts by the laser beams. As belt 36 rotates, in the direction indicated by arrow 56, the toner from each of drums 28, 30, 32 and 34 is transferred to the outside surface of belt 36. As a print medium, such as paper, travels along path 58 or duplexing path 60, the toner is transferred to the surface of the print medium in nip 62.

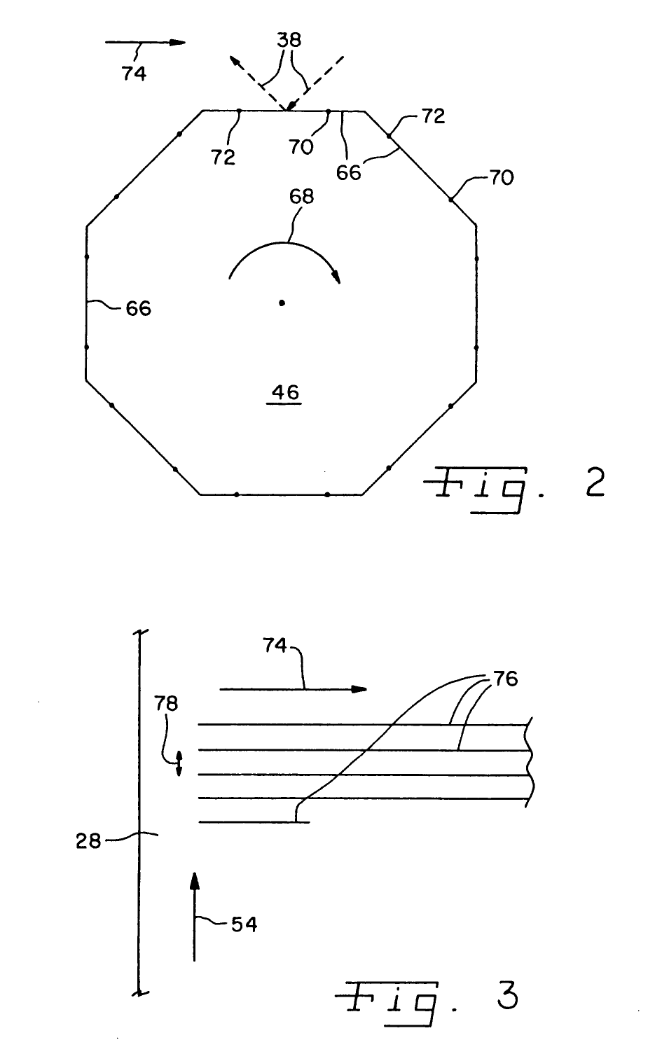

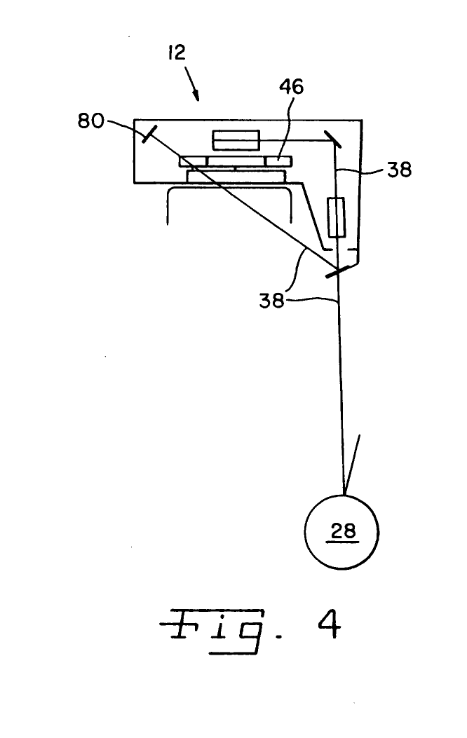

Printheads 12, 14, 16 and 18 are structurally substantially identical. Accordingly, to simplify the discussion and for ease of understanding the invention, only the structure of printhead 12 will be described in detail below in relation to FIGS. 2-4. However, it is to be understood that the discussion that follows with respect to printhead 12 also applies to each of print heads 14, 16 and 18.

Now, additionally referring to FIGS. 2-4, an embodiment of a polygon mirror 46 is shown, as viewed in the direction of arrow 64 in FIG. 1. Polygon mirror 46 is shaped as an octagon with eight reflective sides or facets 66. As polygon mirror 46 rotates in the direction indicated by arrow 68, laser beam 38 reflects off of facets 66 between points 70 and 72 toward photoconductive drum 28. Thus as polygon mirror 46 rotates in direction 68 the reflected laser beam 38 is caused to scan across the peripheral surface of photoconductive drum 28 in a scan direction 74. Scan lines 76 have a separation distance 78 that is dependent on the rotational speed of polygon mirror 46 and the rotational speed of photoconductive drum 28.

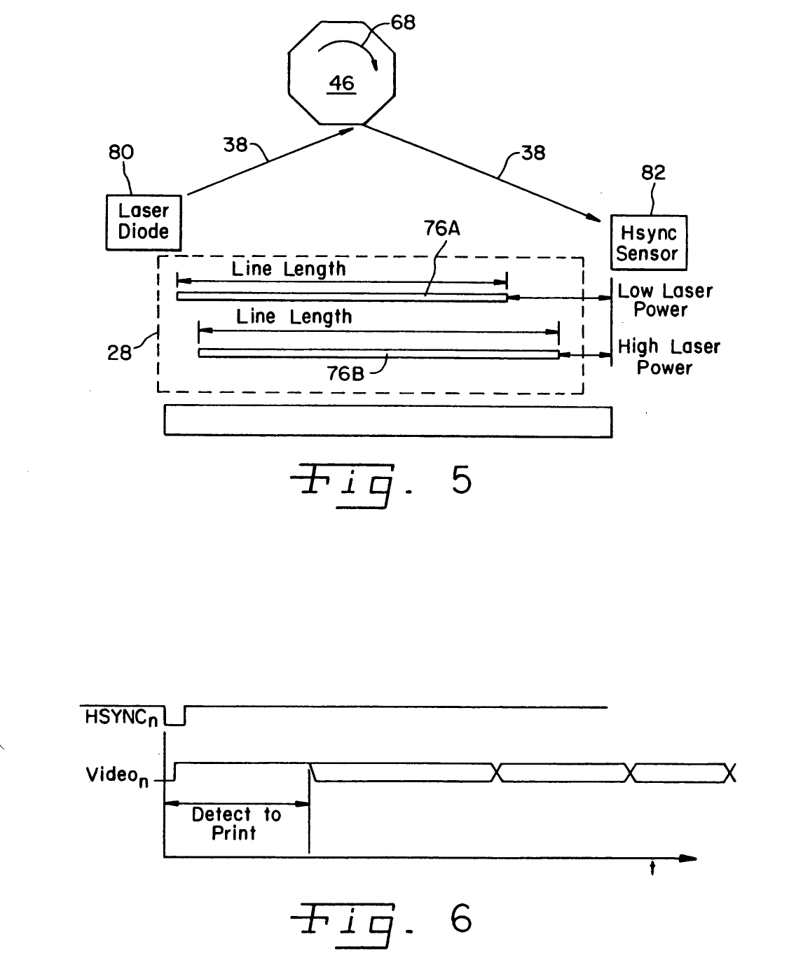

Now, additionally referring to FIG. 5, there is shown a laser 80 producing laser beam 38, which is reflected from a facet 66 on polygon mirror 46. As polygon mirror 46 rotates in direction 68 reflected laser beam 38 crosses a light sensor 82, which is also known as a horizontal synchronous sensor 82 abbreviated as “HSYNC” sensor 82. Laser beam 38 having crossed HSYNC sensor 82 an electronic signal is generated by HSYNC sensor 82 to report the position of laser beam 38, which is used to initiate the beginning of a delay time until the start of a scan line 76. HSYNC sensor 82 is sensitive to light, as such a higher intensity laser beam 38 causes HSYNC sensor 82 to trigger earlier than if laser beam 38 is of a lower intensity. As can be seen in FIG. 5 a scan line 76A produced by a low laser power will be delayed by a greater distance than if a high laser power is utilized as in scan line 76B. This effect exists because HSYNC sensor 82 indicates the beginning of a delay time that then results in a position that scan line 76 begins impinging upon photoconductive drum 28. A variation in the timing of the signal from HSYNC sensor 82 causes the start of a scan line 76 to vary. Assuming that the velocity of rotation of polygon mirror 46 is constant, a shift in the timing of the signal from HSYNC sensor 82 leads to a shift in when the scan line delay time is expired resulting in a positional shift of the scan line.

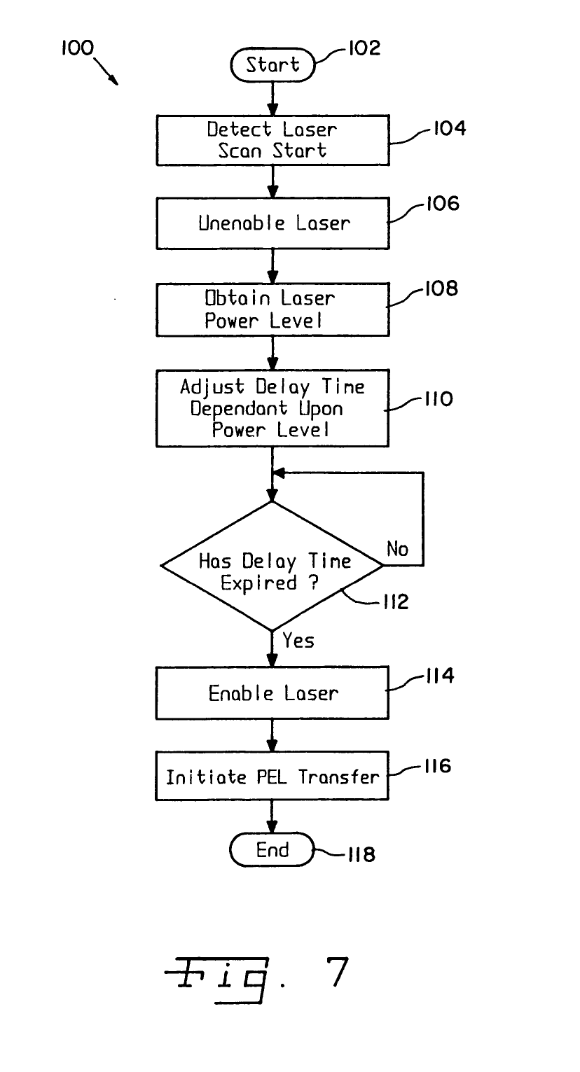

Now, additionally referring to FIG. 6, there is illustrated the relationship between the HSYNCₙ and the Videoₙ signals. Subscript ‘n’ is representative of the color of each printheads 12, 14, 16 and 18. The HSYNCₙ signal is driven low when laser beam 38 crosses HSYNC sensor 82. This triggers the beginning of a delay time indicated as a detect-to-print delay. Videoₙ is an enabling signal for laser diode 80. When Videoₙ is low, laser diode 80 is enabled to illuminate. When Videoₙ is high, laser diode 80 is unenabled. Once the signal from HSYNCₙ is detected, laser diode 80 is unenabled as shown in the Videoₙ signal of FIG. 6. Laser diode 80 remains off or unenabled until the detect-to-print delay time has expired as illustrated in FIG. 6. After the detect-to-print delay has expired, laser diode 80 may be illuminated or not illuminated depending upon the need to place image information, in the form of pels, (a pel is defined as the smallest discrete component of an image), upon photoconductive drum 28 along scan line 76.

It is the variation of the detect-to-print delay time based on the known power output of laser diode 80 that is central to an embodiment of a method of the present invention. The method being illustrated in FIG. 7 as method 100, which starts at step 102 where method 100 is initiated.

As step 104, laser beam 38 is detected by HSYNC sensor 82. As polygon mirror 46 rotates, in direction 68, laser beam 38 is unenabled at step 106. HSYNC sensor 82 generates a signal to controller 37 to indicate the detection of light from laser 80.

At step 108, the laser power level of laser diode 80 is obtained from a memory location. The laser power level has been predetermined and stored in memory by either an automatic system that measures the power intensity of laser diode 80 or by an empirical measurement method from an operator making measurements of a physical media. Additionally, laser power of laser diode 80 may be affected by other adjusting algorithms in engine controller 37 or altered based upon a replacement component within electrophotographic printer 10.

At step 110, the detect-to-print delay time is adjusted based upon the known power level of laser diode 80. The adjustment of the detect-to-print delay time may be a result of an algorithm operating with the known power level of laser diode 80. Alternatively, the adjustment to the detect-to-print delay time is obtained from a lookup table having predetermined delay times relative to specific power level ranges of laser diode 80.

At step 112, method 100 determines whether the detect-to-print delay time has expired. If the detect-to-print delay time has not expired, step 112 returns to itself. If the detect-to-print delay time has expired, then step 112 proceeds to step 114. The detect-to-print delay time that is utilized in step 112 has been altered to properly position the start of scan line 76 as it runs in direction 74.

At step 114, laser diode 80 is enabled. At step 116, the information in the form of a series of pels related to a scan line, from engine controller 37 is transferred by varying the intensity of laser beam 38 as it impinges upon photoconductive drum 28. Method 100 ends at step 118 where engine controller 37 or a control circuit associated with laser printhead 12 performs other functions before reinitiating method 100 for the next scan line 76.

Alternatively, a detect-to-print delay time may be assigned to each of laser printheads 12, 14, 16 and 18 based on measured line registrations of each of the four color cartridges. Laser printheads 14, 16 and 18 are aligned to laser printhead 12 in the present invention.

Advantageously, the variation in a detect-to-print delay time allows for sub-pel size movements along scan line 76. This type of adjustment allows for accurate registration of printheads 14, 16 and 18 relative to black printhead 12. Although the registration of color printheads 14, 16 and 18 to black printhead 12 is completely arbitrary it is a convention utilized in the present invention to describe method 100 herein.

It should be noted that in the present invention the lengths of scan line 76 are unchanged and it is the adjustment of the position of the start of the scan lines that is affected by the present invention. Printer 10 includes a system to measure colors and make adjustments to vary the color quality, this involves the adjustment of laser power. Advantageously, the present invention alleviates or at least minimizes the shifting of scan line 76, caused by an alteration in the laser power output of laser diode 80. The laser power of each color and the black printhead is stored in memory as a result of the color evaluation process. If the laser power is adjusted in this process, then the detect-to-print delay time is adjusted by the present invention so that the start point of the scan line does not vary. If laser power increases, relative to the value stored, then the detect-to-print delay time is increased. Conversely, if laser power decreases, relative to a value stored during alignment, then the detect-to-print delay time is decreased. For example, the laser power may be stored and represented as an 8-bit number varying from 0-255. The relative number stored represents the laser power of laser diode 80. A table stores the values which is use by the printer firmware, to determine the detect-to-print delay that is used for each of the four colors. It is also contemplated that a unique table may be utilized for each of the printheads.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of aligning a print image of an electrophotographic machine, said method comprising the steps of:
determining a power level of a laser;
providing at least one photosensitive development device;
illuminating a light sensor with light from said laser;
generating a signal from said light sensor dependent on said illuminating step;
altering said signal dependent upon said power level; and
starting a scan line from said laser onto at least one said development device dependent upon said altered signal.

2. The method of claim 1, wherein said altering step includes altering a delay time associated with said signal.

3. The method of claim 2, wherein said delay time is increased if said power level is increased.

4. The method of claim 2, wherein said delay time is decreased if said power level is decreased.

5. The method of claim 1, wherein said determining step includes retrieving said power level from a memory location.

6. The method of claim 1, further comprising utilizing said illuminating step, said generating step, said altering step and said starting step with an other laser.

7. The method of claim 6, further comprises the step of coordinating said starting step associated with said laser with said starting step associated with said other laser.

8. A method of aligning a printable image of an electrophotographic machine, said method comprising the steps of:
providing a first photoconductive device associated with a first color toner and a second photoconductive device associated with a second color toner;
projecting a first scan line from a first laser onto said first photoconductive device, said first laser having a first power level associated therewith;
projecting a second scan line from a second laser onto said second photoconductive device, said second laser having a second power level associated therewith;
adjusting at least one of said first power level and said second power level to thereby alter a characteristic of the printable image; and
altering at least one delay time associated with at least one of said projecting a first scan line step and said projecting a second scan line step respectively dependent upon said first power level and said second power level.

9. The method of claim 8, wherein said characteristic is color quality.

10. The method of claim 8, wherein said at least one delay time includes a first delay time associated with said first laser and a second delay time associated with said second laser.

11. The method of claim 10, further comprising the step of coordinating said first delay time and said second delay time to align said first scan line with said second scan line on the printable image.

12. The method of claim 8, wherein said at least one delay time includes a first delay time that is altered dependent upon a predetermined value associated with said first power level.

13. An electrophotographic device, comprising:
at least one rotating multifaceted mirror;
at least one laser producing a light beam directed toward a corresponding one of said at least one rotating multifaceted mirror, said light beam conveying information, said rotating multifaceted mirror reflecting at least a portion of said light beam along a scan line, said at least one laser having an assigned power level; and
at least one light sensor positioned to detect at least a portion of said light beam that is reflected by said at least one rotating multifaceted mirror along said scan line, thereby defining detected light, said at least one light sensor producing a signal dependent upon said detected light, said signal altered by said assigned power level, said signal that is altered is used to initiate said at least one laser to start conveying said information.

14. The electrophotographic device of claim 13, wherein said signal is altered by increasing a delay of said signal if said assigned power level is increased.

15. The electrophotographic device of claim 13, wherein said signal is altered by decreasing a delay time of said signal if said assigned power level is decreased.

16. The electrophotographic device of claim 13, wherein said assigned power level is retrieved from a stored memory location.

17. The electrophotographic device of claim 13, wherein said at least one laser is a plurality of lasers including a first laser and a second laser.

18. The electrophotographic device of claim 17, further comprising a controller that coordinates a delay time associated with said first laser and a delay time associated with said second laser.

19. A method of adjusting the registration of a scan line in an electrophotographic machine, said method comprising the steps of:
determining a power level of a laser beam;
sensing a synch position of said laser beam associated with the scan line; and
varying a delay time before starting the scan line dependent upon said power level and said synch position.

20. The method of claim 19, wherein said delay time is increased if said power level is increased.

21. The method of claim 19, wherein said delay time is decreased if said power level is decreased.

22. The method of claim 19, wherein said determining step includes retrieving said power level from a memory location.

23. The method of claim 19, further comprising utilizing said sensing step and said varying step with an other laser beam.

24. The method of claim 23, further comprises the step of coordinating said varying step associated with said laser beam with said varying step associated with said other laser beam.
